(19) United States
(12) Patent Application Publication
(10) Pub. No.: US 2026/0236322 A1
(43) Pub. Date: Aug. 13, 2026

(54) LOAD BALANCING METHOD, DEVICE, ELECTRONIC DEVICE AND STORAGE MEDIUM

(71) Applicant: Beijing Baidu Netcom Science Technology Co., Ltd., Beijing (CN)

(72) Inventors: Xiaoyu Shi, Beijing (CN); Tengfei Shan, Beijing (CN); Chenfei Wang, Beijing (CN)

(73) Assignee: Beijing Baidu Netcom Science Technology Co., Ltd., Beijing (CN)

(21) Appl. No.: 19/085,890

(22) Filed: Mar. 20, 2025

(30) Foreign Application Priority Data
Feb. 12, 2025 (CN) 202510157450.X

(51) Int. Cl. G06F 9/50

(52) U.S. Cl. CPC G06F 9/5083

(57) ABSTRACT

A method for load balance, an electronic device and a storage medium are provided, and relating to the field of computer technology, and in particular to application fields of cloud computing, big data processing, microservice architecture, Internet of Things and e-commerce. The method for load balance includes selecting a target node from a plurality of service nodes; sending a current request to the target node when determining that no high load identifier of the target node is stored in a load balancer; wherein the target node is used to generate and send a high load identifier of the target node to the load balancer when determining that processing the current request causes the target node to be in a high load state; and storing the high load identifier of the target node.

### TECHNICAL FIELD

The present disclosure relates to the field of computer technology, and in particular to application fields of cloud computing, big data processing, microservice architecture, Internet of Things and e-commerce, and specifically to a method and an apparatus for load balance, an electronic device and a storage medium.

### BACKGROUND

In a distributed system, a plurality of service nodes jointly undertake the task of processing user requests. To this end, currently, a load balancer is usually used to distribute these user requests to the service nodes as evenly as possible.

### SUMMARY

The present disclosure provides a method and an apparatus for load balance, an electronic device and a storage medium.

According to a first aspect of the present disclosure, provided is a method for load balance, including:
selecting a target node from a plurality of service nodes;
sending a current request to the target node when determining that no high load identifier of the target node is stored in a load balancer; where the target node is used to generate and send a high load identifier of the target node to the load balancer when determining that processing the current request causes the target node to be in a high load state; and
storing the high load identifier of the target node.

According to a second aspect of the present disclosure, provided is a method for load balance, including:
receiving a current request sent by a load balancer;
generating a high load identifier of a target node when determining that processing the current request causes the target node to be in a high load state; and
sending the high load identifier of the target node to the load balancer; where the load balancer is used to store the high load identifier of the target node.

According to a third aspect of the present disclosure, provided is an apparatus for load balance, including:
a node selection unit configured to select a target node from a plurality of service nodes;
a request sending unit configured to send a current request to the target node when determining that no high load identifier of the target node is stored in a load balancer; where the target node is used to generate and send a high load identifier of the target node to the load balancer when determining that processing the current request causes the target node to be in a high load state; and
an identifier storage unit configured to store the high load identifier of the target node.

According to a fourth aspect of the present disclosure, provided is an apparatus for load balance, including:
a request receiving unit configured to receive a current request sent by a load balancer;
an identifier generating unit configured to generate a high load identifier of the target node when determining that processing the current request causes the target node to be in a high load state; and
an identifier sending unit configured to send the high load identifier of the target node to the load balancer; where the load balancer is used to store the high load identifier of the target node.

According to a fifth aspect of the present disclosure, provided is an electronic device, including:
at least one processor;
a memory connected in communication with the at least one processor;
where the memory stores an instruction executable by the at least one processor, and the instruction, when executed by the at least one processor, enables the at least one processor to execute the method provided in the first aspect of the present disclosure.

According to a sixth aspect of the present disclosure, provided is a non-transitory computer-readable storage medium storing a computer instruction thereon, and the computer instruction is used to cause a computer to execute the method provided in the first aspect of the present disclosure.

According to a seventh aspect of the present disclosure, provided is a computer program product including a computer program, and the computer program implements the method provided in the first aspect of the present disclosure, when executed by a processor.

The present disclosure can ensure the high robustness of the distributed system.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a method for load balance according to an embodiment of the present disclosure;

FIG. 2 is a schematic flowchart of another method for load balance according to an embodiment of the present disclosure;

FIG. 3 is a diagram illustrating an integrity process of a method for load balance according to an embodiment of the present disclosure;

FIG. 4 is a schematic diagram of an application scenario of a method for load balance according to an embodiment of the present disclosure;

FIG. 5 is a schematic structural block diagram of an apparatus for load balance according to an embodiment of the present disclosure;

FIG. 6 is a schematic structural block diagram of another apparatus for load balance according to an embodiment of the present disclosure; and

FIG. 7 is a schematic structural block diagram of an electronic device according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

As described in the background, a plurality of service nodes jointly undertake the task of processing user requests in the distributed system. To this end, currently, a load balancer is usually used to distribute these user requests to the service nodes as evenly as possible. Specifically and currently, the load balancer generally uses the polling method or hashing method to select a target node from the plurality of service nodes to process a newly received user request that is not allocated to a service node, thereby achieving the purpose of distributing these user requests to the service nodes as evenly as possible. However, the inventors have discovered that due to the significant differences in the back-end resources required to process various types of user requests, it is difficult to balance the load of each service node although these two method for load balance can balance the quantity of user requests received by each service node, so that it is easy to cause some service nodes to be in the high load state for a long time and be unable to process the received user requests timely and effectively, thereby affecting the overall response speed of the distributed system and thus affecting the robustness of the distributed system.

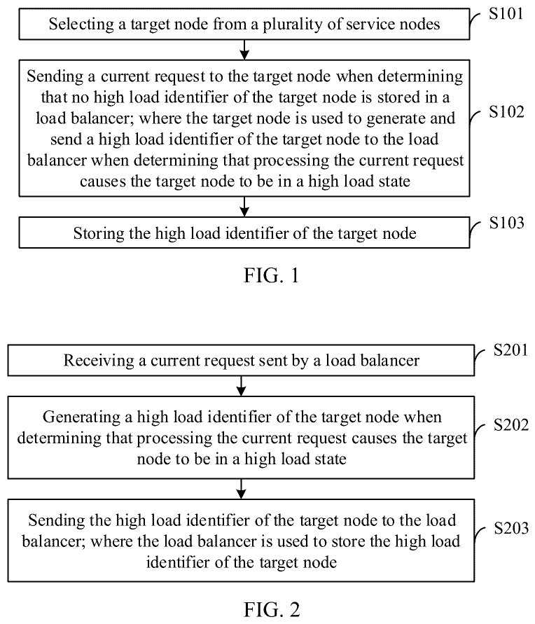

In view of the above problem, an embodiment of the present disclosure provides a method for load balance, and this method may be applied to a load balancer included in the distributed system. Here, the load balancer may be a server, a workbench, a large-scale computer, a conventional computer (desktop computer, laptop, etc.) or any other similar hardware device, or may be a virtual balancer simulated inside a hardware device. Moreover, it should be noted that the distributed system further includes a plurality of service nodes (i.e., candidate service nodes) connected to the load balancer in the embodiment of the present disclosure. Here, each of the plurality of service nodes may be a server, a workbench, a large-scale computer, a conventional computer or any other similar hardware device, or may be a virtual node simulated inside a hardware device; and the plurality of service nodes may be simulated inside different hardware devices or inside a same hardware device. Hereinafter, a method for load balance according to an embodiment of the present disclosure will be described in combination with the schematic flowchart shown in FIG. 1. It should be noted that a logical sequence is shown in the schematic flowchart, but the steps shown or described in the flowchart may also be performed in other sequences in some cases.

Step S101: selecting a target node from a plurality of service nodes.

For example, the polling method or hashing method may be used to select the target node from the plurality of service nodes.

Step S102: sending a current request to the target node when determining that no high load identifier of the target node is stored in a load balancer.

In one example, the current request may be sent to the target node when it is determined that no high load identifier of the target node is not stored in the memory of the load balancer. Here, the current request may be a user request newly received by the load balancer and not allocated to a service node.

Moreover, it should be noted that, in the embodiment of the present disclosure, when it is determined that no high load identifier of the target node is not stored in the load balancer, it can be considered that the target node is not in the high load state, that is, it can be considered that the target node is in the medium/low load state.

The fact that the target node is in the high load state may be: at least one of a plurality of load evaluation indexes of the target node satisfies the corresponding high load evaluation requirement; and correspondingly, the fact that the target node is in the medium/low load state may be: each of the plurality of load evaluation indexes of the target node satisfies the corresponding medium/low load evaluation requirement.

Exemplarily, the plurality of load evaluation indexes include CPU (Central Processing Unit) occupancy rate, remaining memory amount, and the quantity of current processes. Moreover, the high load evaluation requirement corresponding to the CPU occupancy rate is that the CPU occupancy rate is greater than or equal to 80%, the high load evaluation requirement corresponding to the remaining memory amount is that the remaining memory amount is less than or equal to 2G, and the high load evaluation requirement corresponding to the quantity of current processes is that the quantity of current processes is greater than or equal to 800; the medium/low load evaluation requirement corresponding to the CPU occupancy rate is that the CPU occupancy rate is less than 80%, the medium/low load evaluation requirement corresponding to the remaining memory amount is that the remaining memory amount is greater than 2G, and the medium/low load evaluation requirement corresponding to the quantity of current processes is that the quantity of current processes is less than 800. Then, when at least one of the following three conditions is true: the CPU occupancy rate of the target node is greater than or equal to 80%, the remaining memory amount of the target node is less than or equal to 2G, or the quantity of current processes of the target node is greater than or equal to 800, it can be determined that the target node is in the high load state; when all of the following three conditions are true: the CPU occupancy rate of the target node is less than 80%, the remaining memory amount of the target node is greater than 2G, and the quantity of current processes of the target node is less than 800, it can be determined that the target node is in the medium/low load state.

Further, in the embodiment of the present disclosure, after the load balancer sends the current request to the target node and the target node receives the current request, the target node may generate and send a high load identifier of the target node to the load balancer when determining that processing the current request causes the target node to be in the high load state. For example, the high load identifier of the target node may be carried in a request feedback result (i.e., Http feedback message) corresponding to the current request and sent to the load balancer.

Step S103: storing the high load identifier of the target node.

In one example, the high load identifier of the target node may be stored in the memory of the load balancer.

With the method for load balance provided in the embodiment of the present disclosure, after the target node is selected from the plurality of service nodes, the current request is not directly sent to the target node. Instead, the current request is sent to the target node only when it is determined that no high load identifier of the target node is stored in the load balancer (that is, the target node is in the medium/low load state). Moreover, after receiving the current request, the target node may generate the high load identifier of the target node when determining that processing the current request causes itself to be in the high load state, and send the high load identifier of the target node to the load balancer so that the load balancer stores the high load identifier of the target node. In this way, it is possible to avoid the target node from receiving and attempting to process the current request when the target node is in the high load state, which causes the target node to be in the high load state for a long time and thus unable to process the current request timely and effectively, thereby ensuring the overall response speed of the distributed system. This will enable the distributed system to operate stably even in extreme situations (for example, large traffic shock), thus ensuring the high robustness of the distributed system.

Moreover, as mentioned above, the polling method or hashing method may be used to select the target node from the plurality of service nodes in the embodiment of the present disclosure. In addition, in the embodiment of the present disclosure, the target node may also be selected from the plurality of service nodes by:
obtaining an overall load state of the plurality of service nodes;
selecting a first target strategy from a plurality of candidate strategies based on the overall load state of the plurality of service nodes; and
selecting the target node from the plurality of service nodes according to the first target strategy.

Here, the overall load state of the plurality of service nodes may be used to represent the high load proportion of the plurality of service nodes, and the high load proportion of the plurality of service nodes may be obtained using the following proportion calculation logic:

$$P = M 1 / M 2.$$

Here, P is used to represent the high load proportion of the plurality of service nodes; M1 is used to represent the quantity of high load identifiers stored in the load balancer; and M2 is used to represent the quantity of service nodes included in the distributed system.

Moreover, in the embodiment of the present disclosure, after the overall load state of the plurality of service nodes (that is, the high load proportion of the plurality of service nodes) is obtained, a first selection strategy among the plurality of candidate strategies may be determined as the first target strategy when it is determined that the high load proportion of the plurality of service nodes satisfies a preset medium/low proportion requirement, or a second selection strategy among the plurality of candidate strategies may be determined as the first target strategy when it is determined that the high load proportion of the plurality of service nodes satisfies a preset high proportion requirement. Here, the preset medium/low proportion requirement may be set according to actual application requirements, for example, the high load proportion of the plurality of service nodes may be set to be less than or equal to 70%, which is not limited in the embodiment of the present disclosure; the first selection strategy may be used to indicate to select the target node from the plurality of service nodes by using the polling method or hashing method; the preset high proportion requirement may be set according to actual application requirements, for example, the high load proportion of the plurality of service nodes may be set to be greater than 70%, which is not limited in the embodiment of the present disclosure; and the second selection strategy may be used to indicate to select a service node with the lowest load from the plurality of service nodes as the target node, for example, select a service node with the lowest load score from the plurality of service nodes as the target node.

In one example, the load score of each service node among the plurality of service nodes may be obtained by the following load calculation logic:

$$Load Score ( ) = {\sum }_{i = 1}^{N} w i ( f i ( x i ) ) .$$

Here, Load Score (j) is used to represent the load score of the j-th service node among the plurality of service nodes; N is used to represent the quantity of load evaluation indexes of the j-th service node; wi is used to represent the load weight value corresponding to the i-th load evaluation index among the N load evaluation indexes, and may be specifically set according to actual application requirements, and is not limited in the embodiment of the present disclosure; and fi (xi) is the normalized processing result for the i-th load evaluation index.

In a specific example, when the i-th load evaluation index is a positive index (that is, a load evaluation index with a larger value indicating a greater load contribution to the service node, such as CPU occupancy rate and the quantity of current processes):

$$fi ( xi ) = \frac{x i}{Max i} .$$

Here, xi is used to represent the value of the i-th load evaluation index; and Maxi is used to represent the normalized reference value corresponding to the i-th load evaluation index. For example, when the i-th load evaluation index is the CPU occupancy rate, Maxi may be 1; and when the i-th load evaluation index is the quantity of current processes, Maxi may be the maximum quantity of processes that the j-th service node can run simultaneously. Here, the value of the i-th load evaluation index may be obtained from the request feedback result newly received by the load balancer. That is, after receiving a user request, the target node may carry the value of each of the N load evaluation indexes of the target node in the request feedback result corresponding to the user request when sending the request feedback result to the load balancer; and the normalized reference value corresponding to the i-th load evaluation index may be pre-stored in the load balancer, for example, may be pre-stored in the memory of the load balancer.

Correspondingly, when the i-th load evaluation index is a reverse index (that is, a load evaluation index with a smaller value indicating a greater load contribution to the service node, such as remaining memory amount):

$$fi ( xi ) = 1 - \frac{x i}{Max i} .$$

Here, xi is used to represent the value of the i-th load evaluation index; and Maxi is used to represent the normalized reference value corresponding to the i-th load evaluation index. For example, when the i-th load evaluation index is the remaining memory amount, Maxi may be the total memory amount of the j-th service node. Here, the value of the i-th load evaluation index may be obtained from the request feedback result newly received by the load balancer. That is, after receiving a user request, the target node may carry the value of each of the N load evaluation indexes of the target node in the request feedback result corresponding to the user request when sending the request feedback result to the load balancer; and the normalized reference value corresponding to the i-th load evaluation index may be pre-stored in the load balancer, for example, may be pre-stored in the memory of the load balancer.

In the above manner, the target node may be selected from the plurality of service nodes based on the overall load state of the plurality of service nodes in the embodiment of the present disclosure. Specifically, when it is determined based on the overall load state of the plurality of service nodes that the high load proportion of the plurality of service nodes satisfies the preset medium/low proportion requirement, the polling method or hashing method may be used to select the target node from the plurality of service nodes; or, when it is determined based on the overall load state of the plurality of service nodes that the high load proportion of the plurality of service nodes satisfies the preset high proportion requirement, the service node with the lowest load may be selected from the plurality of service nodes as the target node. In this way, it can be ensured as much as possible that the selected target node is not in the high load state, and there is no need to select a new target node from the plurality of service nodes to receive and attempt to process the current request, thereby further improving the processing efficiency of the current request.

Based on this, it can be understood that, in the embodiment of the present disclosure, when the target node is selected from the plurality of service nodes and it is determined that the high load identifier of the target node is stored in the load balancer, a new target node may be selected from the plurality of service nodes; and when it is determined that no high load identifier of the new target node is stored in the load balancer, the current request may be sent to the new target node.

In one example, the polling method or hashing method may be used to select the new target node from the plurality of service nodes. In another example, the new target node may also be selected from the plurality of service nodes by:
obtaining an overall load state of the plurality of service nodes;
selecting a second target strategy from a plurality of candidate strategies based on the overall load state of the plurality of service nodes; and
selecting the new target node from the plurality of service nodes according to the second target strategy.

The explanations and examples of the above process can refer to the description of the above-mentioned section “selecting the target node from the plurality of service nodes”, and will not be repeated here.

Further, in the embodiment of the present disclosure, the high load identifier of the target node may be the first high load identifier (for example, OverLoad) or second high load identifier (for example, 3XX). Here, the first high load identifier is used to indicate that processing the current request causes the target node to be in a nearly full load state under the high load state; and the second high load identifier is used to indicate that processing the current request causes the target node to be in a full load state under the high load state.

Based on this, it should be noted that, in the embodiment of the present disclosure, when determining that processing the current request causes the target node to be in the nearly full load state under the high load state, the target node may continue to process the current request, obtain a request feedback result corresponding to the current request, and send the request feedback result to the load balancer after carrying the first high load identifier of the target node in the request feedback result; and correspondingly, when determining that processing the current request causes the target node to be in the full load state under the high load state, the target node may not process the current request, but directly carry the second high load identifier of the target node in the request feedback result corresponding to the current request, and send the request feedback result to the load balancer. When receiving the request feedback result corresponding to the current request and determining that the second high load identifier is carried therein, the load balancer may select a substitute node from the plurality of service nodes, and send the current request to the substitute node when determining that no high load identifier of the substitute node is stored in the load balancer.

In one example, the polling method or hashing method may be used to select the substitute node from the plurality of service nodes. In another example, the substitute node may also be selected from the plurality of service nodes by:
obtaining an overall load state of the plurality of service nodes;
selecting a third target strategy from a plurality of candidate strategies based on the overall load state of the plurality of service nodes; and
selecting the substitute node from the plurality of service nodes according to the third target strategy.

The explanations and examples of the above process may refer to the description of the above-mentioned section “selecting the target node from the plurality of service nodes”, and will not be repeated here.

Further, in an example, the fact that the target node is in the nearly full load state under the high load state may be: none of the plurality of load evaluation indexes of the target node satisfies the corresponding medium full load evaluation requirement, but at least one load evaluation index satisfies the corresponding nearly full load evaluation requirement; and correspondingly, the fact that the target node is in the full load state under the high load state may be: at least one of the plurality of load evaluation indexes of the target node satisfies the corresponding full load evaluation requirement.

Exemplarily, the plurality of load evaluation indexes include CPU occupancy rate, remaining memory amount, and the quantity of current processes. Moreover, the nearly full load evaluation requirement corresponding to the CPU occupancy rate is that the CPU occupancy rate is greater than or equal to 80%, the nearly full load evaluation requirement corresponding to the remaining memory amount is that the remaining memory amount is less than or equal to 2G, and the nearly full load evaluation requirement corresponding to the quantity of current processes is that the quantity of current processes is greater than or equal to 800; the full load evaluation requirement corresponding to the CPU occupancy rate is that the CPU occupancy rate is greater than or equal to 90%, the full load evaluation requirement corresponding to the remaining memory amount is that the remaining memory amount is less than or equal to 1G, and the full load evaluation requirement corresponding to the quantity of current processes is that the quantity of current processes is greater than or equal to 900. Then, when none of the following three conditions is true: the CPU occupancy rate of the target node is greater than or equal to 90%, the remaining memory amount of the target node is less than or equal to 1G, and the quantity of current processes of the target node is greater than or equal to 900; but at least one of the following three conditions is true: the CPU occupancy rate of the target node is greater than or equal to 80%, the remaining memory amount of the target node is less than or equal to 2G, or the quantity of current processes of the target node is greater than or equal to 800, it can be determined that the target node is in the nearly full load state under the high load state. When at least one of the following three conditions is true: the CPU occupancy rate of the target node is greater than or equal to 90%, the remaining memory amount of the target node is less than or equal to 1G, or the quantity of current processes of the target node is greater than or equal to 900, it can be determined that the target node is in the full load state under the high load state.

Based on this, in some optional implementations, after executing step S103, that is, after storing the high load identifier of the target node, the method for load balance may further include:
obtaining a duration threshold;
obtaining a storage duration of the high load identifier of the target node in the load balancer; and
clearing the high load identifier of the target node stored in the load balancer when determining that the storage duration is greater than or equal to the duration threshold.

Here, the duration threshold may be a preset fixed value or may be a variable value obtained by real-time calculation, and is not limited in the embodiment of the present disclosure.

In the above manner, in the embodiment of the present disclosure, the duration threshold and the storage duration of the high load identifier of the target node in the load balancer can be obtained; and when it is determined that the storage duration is greater than or equal to the duration threshold, the high load identifier of the target node stored in the load balancer is cleared, that is, the high load identifier of the target node is deleted from the load balancer. In this way, the target node can be automatically marked as the medium/low load state after a period of time, so as to start receiving and trying to process a new user request. This can not only improve the degree of automation of the distributed system, but also ensure as much as possible that there are normally more available nodes in distributed system, thereby further improving the overall response speed of the distributed system.

Further, in an example, “obtaining a duration threshold” may include:
obtaining the duration threshold based on a first basic duration when the high load identifier of the target node is a first high load identifier.

Here, the first basic duration may be set according to actual application requirements, for example, may be set to 5 minutes (Min), and is not limited in the embodiment of the present disclosure.

Moreover, as mentioned above, the duration threshold may be a preset fixed value in the embodiment of the present disclosure. Based on this, in a specific example, “obtaining the duration threshold based on a first basic duration” may include: using the first basic duration directly as the duration threshold. In this way, the efficiency in obtaining the duration threshold can be improved, so as to further improve the overall response speed of the distributed system.

Likewise, as mentioned above, the duration threshold may also be a variable value obtained by real-time calculation in the embodiment of the present disclosure. Based on this, in a specific example, “obtaining the duration threshold based on a first basic duration” may include:
obtaining a state transition duration of the target node as a first incremental duration; and
obtaining the duration threshold based on the first basic duration and the first incremental duration.

Here, the state transition duration may be used to indicate a length of time required for the target node to transition from the high load state to the medium/low load state, and specifically, may be used to indicate a length of time required for the target node to transition from the high load state to the medium/low load state for the most recent time within a historical period. Here, the state transition duration may be recorded by the target node and carried in a specific feedback result, which is then sent to the load balancer. The specific feedback result may be the first request feedback result sent by the target node to the load balancer after the target node transitions from the high load state to the medium/low load state for the most recent time within the historical period.

After the first incremental duration is obtained, the first basic duration may be directly used as the duration threshold when the first basic duration is greater than or equal to the first incremental duration; or, the first incremental duration may be directly used as the duration threshold when the first basic duration is less than the first incremental duration.

In another specific example, “obtaining the duration threshold based on a first basic duration” may also include:
obtaining a first incremental duration based on a current flow index of the distributed system; and
obtaining the duration threshold based on the first basic duration and the first incremental duration.

Here, the first incremental duration is positively correlated with the current flow index. Based on this, it can be understood that a longer time length may be set as the first incremental duration during a flow peak period; and a shorter time length may be set as the first incremental duration during a flow trough period.

After the first incremental duration is obtained, the sum of the first basic duration and the first incremental duration may be used as the duration threshold.

In the above manner, the duration threshold may be obtained based on the first basic duration when the high load identifier of the target node is the first high load identifier in the embodiment of the present disclosure. Specifically, the state transition duration of the target node may be obtained as the first incremental duration, and the duration threshold may be obtained based on the first basic duration and the first incremental duration; or, the first incremental duration may be obtained based on the current flow index of the distributed system, and the duration threshold may be obtained based on the first basic duration and the first incremental duration. In this way, the duration threshold may be dynamically obtained, thereby avoiding the duration threshold from being set too long or too short, that is, the rationality of the duration threshold can be ensured, so that not only the overall response speed of the distributed system can be ensured, but also the stability of the distributed system can be ensured.

In another example, “obtaining a duration threshold” may include:
obtaining the duration threshold based on a second basic duration when the high load identifier of the target node is a second high load identifier.

Here, the second basic duration is greater than the first basic duration. Here, the second basic duration may be set according to actual application requirements. For example, when the first basic duration is set to 5 Min, the second basic duration may be set to 10 Min, which is not limited in the embodiment of the present disclosure.

Moreover, as mentioned above, the duration threshold may be a preset fixed value in the embodiment of the present disclosure. Based on this, in a specific example, “obtaining the duration threshold based on a second basic duration” may include: using the second basic duration directly as the duration threshold. In this way, the efficiency in obtaining the duration threshold can be improved, so as to further improve the overall response speed of the distributed system.

Likewise, as mentioned above, the duration threshold may also be a variable value obtained by real-time calculation in the embodiment of the present disclosure. Based on this, in a specific example, “obtaining the duration threshold based on a second basic duration” may include:
obtaining a state transition duration of the target node as a second incremental duration; and
obtaining the duration threshold based on the second basic duration and the second incremental duration.

Here, the state transition duration may be used to indicate a length of time required for the target node to transition from the high load state to the medium/low load state, and specifically, may be used to indicate a length of time required for the target node to transition from the high load state to the medium/low load state for the most recent time within a historical period. Here, the state transition duration may be recorded by the target node and carried in a specific feedback result, which is then sent to the load balancer. The specific feedback result may be the first request feedback result sent by the target node to the load balancer after the target node transitions from the high load state to the medium/low load state for the most recent time within the historical period.

After the second incremental duration is obtained, the second basic duration may be directly used as the duration threshold when the second basic duration is greater than or equal to the second incremental duration; or, the second incremental duration may be directly used as the duration threshold when the second basic duration is less than the second incremental duration.

In another specific example, “obtaining the duration threshold based on a second basic duration” may also include:
obtaining a second incremental duration based on a current flow index of the distributed system; and
obtaining the duration threshold based on the second basic duration and the second incremental duration.

Here, the second incremental duration is positively correlated with the current flow index. Based on this, it can be understood that a longer time length may be set as the second incremental duration during a flow peak period; and a shorter time length may be set as the second incremental duration during a flow trough period.

After the second incremental duration is obtained, the sum of the second basic duration and the second incremental duration may be used as the duration threshold.

In the above manner, the duration threshold may be obtained based on the second basic duration when the high load identifier of the target node is the second high load identifier in the embodiment of the present disclosure. Specifically, the state transition duration of the target node may be obtained as the second incremental duration, and the duration threshold may be obtained based on the second basic duration and the second incremental duration; or, the second incremental duration may be obtained based on the current flow index of the distributed system, and the duration threshold may be obtained based on the second basic duration and the second incremental duration. In this way, the duration threshold may be dynamically obtained, thereby avoiding the duration threshold from being set too long or too short, that is, the rationality of the duration threshold can be ensured, so that not only the overall response speed of the distributed system can be ensured, but also the stability of the distributed system can be ensured.

An embodiment of the present disclosure further provides a method for load balance, which may be applied to a plurality of service nodes included in the distributed system, and specifically, may be a target node selected by a load balancer from the plurality of service nodes. Here, each of the plurality of service nodes may be a server, a workbench, a large-scale computer, a conventional computer or any other similar hardware device, or may be a virtual node simulated inside a hardware device; and the plurality of service nodes may be simulated inside different hardware devices or inside a same hardware device. Hereinafter, a method for load balance according to an embodiment of the present disclosure will be described in combination with the schematic flowchart shown in FIG. 2. It should be noted that a logical sequence is shown in the schematic flowchart, but the steps shown or described in the flowchart may also be performed in other sequences in some cases.

Step S201: receiving a current request sent by a load balancer.

Here, the current request may be a user request newly received by the load balancer and allocated to a target node.

Step S202: generating a high load identifier of the target node when determining that processing the current request causes the target node to be in a high load state.

Here, the fact that the target node is in the high load state may be: at least one of a plurality of load evaluation indexes of the target node satisfies the corresponding high load evaluation requirement.

Exemplarily, the plurality of load evaluation indexes include CPU occupancy rate, remaining memory amount, and the quantity of current processes. Moreover, the high load evaluation requirement corresponding to the CPU occupancy rate is that the CPU occupancy rate is greater than or equal to 80%, the high load evaluation requirement corresponding to the remaining memory amount is that the remaining memory amount is less than or equal to 2G, and the high load evaluation requirement corresponding to the quantity of current processes is that the quantity of current processes is greater than or equal to 800. Then, when at least one of the following three conditions is true: the CPU occupancy rate of the target node is greater than or equal to 80%, the remaining memory amount of the target node is less than or equal to 2G, or the quantity of current processes of the target node is greater than or equal to 800, it can be determined that the target node is in the high load state.

Step S203: sending the high load identifier of the target node to the load balancer.

For example, the high load identifier of the target node may be carried in the request feedback result corresponding to the current request and sent to the load balancer.

Moreover, in the embodiment of the present disclosure, the load balancer may be used to store the high load identifier of the target node, for example, to store the high load identifier of the target node in the memory of the load balancer.

In the method for load balance provided in the embodiment of the present disclosure, when receiving the current request sent by the load balancer and determining that processing the current request causes the target node to be in the high load state, the high load identifier of the target node can be generated and then sent to the load balancer so that the load balancer can store the high load identifier of the target node. In this way, it is possible to avoid the target node from being selected by the load balancer again to receive and attempt to process a new user request, which causes the target node to be in the high load state for a long time and thus unable to process the new user request timely and effectively, thereby ensuring the overall response speed of the distributed system. This will enable the distributed system to operate stably even when facing large traffic shock, that is, the high robustness of the distributed system can be ensured.

In some optional implementations, step S202, that is, “generating a high load identifier of the target node when determining that processing the current request causes the target node to be in a high load state” may include:
generating a first high load identifier (for example, OverLoad) of the target node when determining that processing the current request causes the target node to be in a nearly full load state under the high load state.

Here, the fact that the target node is in the nearly full load state under the high load state may be: none of a plurality of load evaluation indexes of the target node satisfies the corresponding medium full load evaluation requirement, but at least one load evaluation index satisfies the corresponding nearly full load evaluation requirement.

Exemplarily, the plurality of load evaluation indexes include CPU occupancy rate, remaining memory amount, and the quantity of current processes. Moreover, the nearly full load evaluation requirement corresponding to the CPU occupancy rate is that the CPU occupancy rate is greater than or equal to 80%, the nearly full load evaluation requirement corresponding to the remaining memory amount is that the remaining memory amount is less than or equal to 2G, and the nearly full load evaluation requirement corresponding to the quantity of current processes is that the quantity of current processes is greater than or equal to 800; the full load evaluation requirement corresponding to the CPU occupancy rate is that the CPU occupancy rate is greater than or equal to 90%, the full load evaluation requirement corresponding to the remaining memory amount is that the remaining memory amount is less than or equal to 1G, and the full load evaluation requirement corresponding to the quantity of current processes is that the quantity of current processes is greater than or equal to 900. Then, when none of the following three conditions is true: the CPU occupancy rate of the target node is greater than or equal to 90%, the remaining memory amount of the target node is less than or equal to 1G, and the quantity of current processes of the target node is greater than or equal to 900; but at least one of the following three conditions is true: the CPU occupancy rate of the target node is greater than or equal to 80%, the remaining memory amount of the target node is less than or equal to 2G, or the quantity of current processes of the target node is greater than or equal to 800, it can be determined that the target node is in the nearly full load state under high load state.

In one example, whether processing the current request causes the target node to be in the nearly full load state under the high load state may be determined based on the load consumed when processing a reference request in a historical period. Here, the reference request may be a user request belonging to the same category as the current request.

Moreover, it should be noted that, in the embodiment of the present disclosure, when determining that processing the current request causes the target node to be in the nearly full load state under the high load state, the target node may continue to process the current request, obtain a request feedback result corresponding to the current request, and send the request feedback result to the load balancer after carrying the first high load identifier of the target node in the request feedback result.

In some optional implementations, step S202, that is, “generating a high load identifier of the target node when determining that processing the current request causes the target node to be in a high load state” may also include:
generating a second high load identifier (for example, 3XX) of the target node when determining that processing the current request causes the target node to be in a full load state under the high load state.

In one example, the fact that the target node is in the full load state under the high load state may be: at least one of a plurality of load evaluation indexes of the target node satisfies the corresponding full load evaluation requirement.

Exemplarily, the plurality of load evaluation indexes include CPU occupancy rate, remaining memory amount, and the quantity of current processes. Moreover, the full load evaluation requirement corresponding to the CPU occupancy rate is that the CPU occupancy rate is greater than or equal to 90%, the full load evaluation requirement corresponding to the remaining memory amount is that the remaining memory amount is less than or equal to 1G, and the full load evaluation requirement corresponding to the quantity of current processes is that the quantity of current processes is greater than or equal to 900. Then, when at least one of the following three conditions is true: the CPU occupancy rate of the target node is greater than or equal to 90%, the remaining memory amount of the target node is less than or equal to 1G, or the quantity of current processes of the target node is greater than or equal to 900, it can be determined that the target node is in the full load state under the high load state.

In one example, whether processing the current request causes the target node to be in the full load state under the high load state may be determined based on the load consumed when processing a reference request in a historical period. Here, the reference request may be a user request belonging to the same category as the current request.

Moreover, it should be noted that, in the embodiment of the present disclosure, when determining that processing the current request causes the target node to be in the full load state under the high load state, the target node may not process the current request, but directly carry the second high load identifier of the target node in the request feedback result corresponding to the current request, and send the request feedback result to the load balancer. When receiving the request feedback result corresponding to the current request and determining that the second high load identifier is carried therein, the load balancer may select a substitute node from the plurality of service nodes, and send the current request to the substitute node when determining that no high load identifier of the substitute node is stored in the load balancer.

Through the above method, in the embodiment of the present disclosure, when it is determined that processing the current request causes the target node to be in the nearly full load state under the high load state, the first high load identifier of the target node can be generated; or, when it is determined that processing the current request causes the target node to be in the full load state under the high load state, the second high load identifier of the target node can be generated. In this way, the load balancer can dynamically obtain the duration threshold based on the specific high load identifier received, thereby avoiding the duration threshold from being set too long or too short, that is, the rationality of the duration threshold can be ensured, so that not only the overall response speed of the distributed system can be ensured, but also the stability of the distributed system can be ensured.

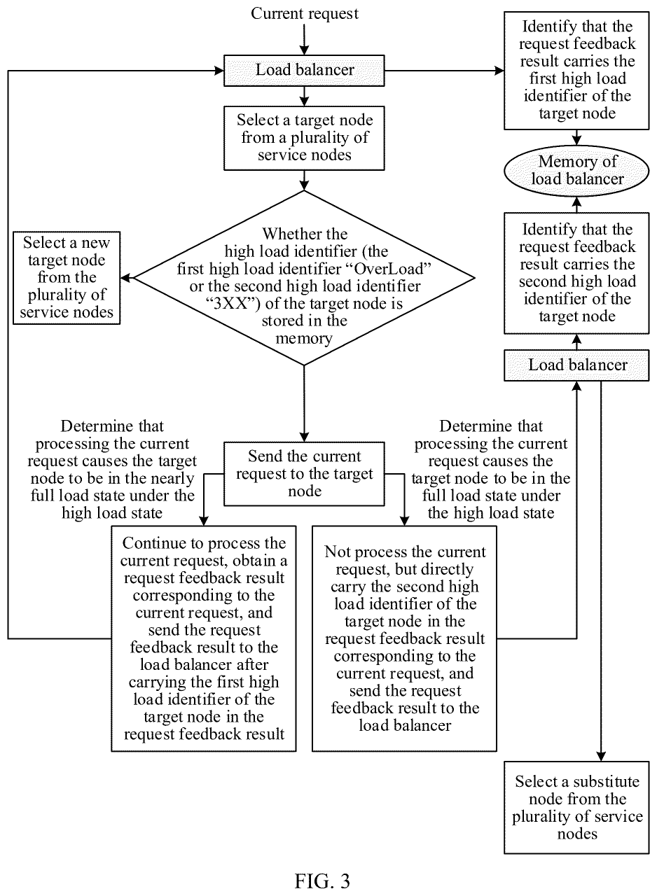

Hereinafter, the complete process of a method for load balance according to an embodiment of the present disclosure will be described in combination with FIG. 3.

Firstly, the load balancer (two load balancers in FIG. 3 are the same load balancer) selects a target node from a plurality of service nodes after receiving a current request. For example, the polling method or hashing method may be used to select the target node from the plurality of service nodes.

After that, the load balancer may query whether the high load identifier (the first high load identifier “OverLoad” or the second high load identifier “3XX”) of the target node is stored in the memory, to select a new target node from the plurality of service nodes when determining that the high load identifier of the target node is stored in the memory of the load balancer, and send the current request to the new target node when determining that no high load identifier of the new target node is stored in the load balancer; or, send the current request to the target node when determining that no high load identifier of the target node is stored in the memory of the load balancer.

Next, the target node generates a first high load identifier of the target node when determining that processing the current request causes the target node to be in the nearly full load state under the high load state. Specifically, in the embodiment of the present disclosure, when determining that processing the current request causes the target node to be in the nearly full load state under the high load state, the target node may continue to process the current request, obtain a request feedback result corresponding to the current request, and send the request feedback result to the load balancer after carrying the first high load identifier of the target node in the request feedback result, so that the load balancer stores the first high load identifier of the target node in the memory of the load balancer when identifying that the request feedback result carries the first high load identifier of the target node.

Correspondingly, the target node generates a second high load identifier of the target node when determining that processing the current request causes the target node to be in the full load state under the high load state. Specifically, in the embodiment of the present disclosure, when determining that processing the current request causes the target node to be in the full load state under the high load state, the target node may not process the current request, but directly carry the second high load identifier of the target node in the request feedback result corresponding to the current request, and send the request feedback result to the load balancer, so that the load balancer stores the second high load identifier of the target node in the memory of the load balancer when identifying that the request feedback result carries the second high load identifier of the target node. At the same time, a substitute node is also selected from the plurality of service nodes, and the current request is sent to the substitute node when it is determined that no high load identifier of the substitute node is stored in the load balancer.

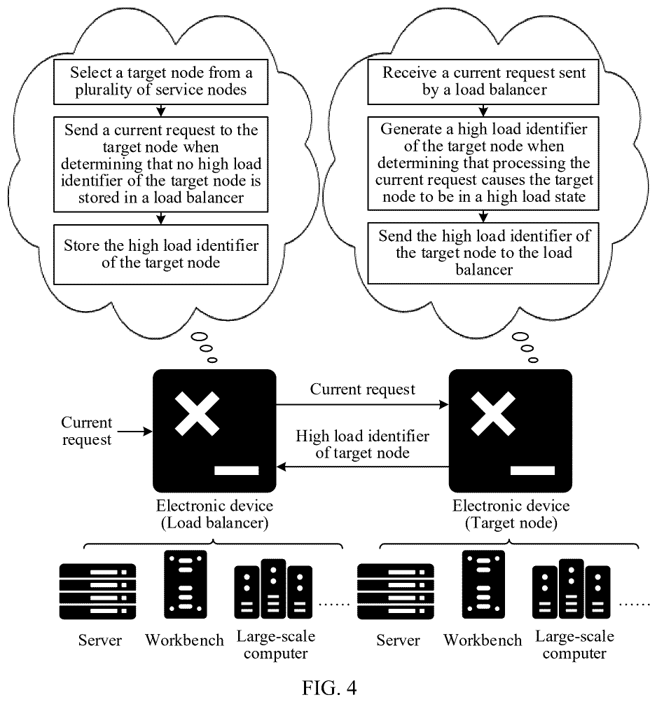

Referring to FIG. 4, FIG. 4 is a schematic diagram of an application scenario of a method for load balance according to an embodiment of the present disclosure.

As mentioned above, the method for load balance according to the embodiment of the present disclosure is applied to an electronic device.

Here, the electronic device may be a load balancer included in the distributed system.

Here, the load balancer may be a server, a workbench, a large-scale computer, a conventional computer or any other similar hardware device, or may be a virtual balancer simulated inside a hardware device.

At this point, the electronic device is configured to:
select a target node from a plurality of service nodes;
send a current request to the target node when determining that no high load identifier of the target node is stored in a load balancer; where the target node is used to generate and send a high load identifier of the target node to the load balancer when determining that processing the current request causes the target node to be in a high load state; and
store the high load identifier of the target node.

Here, the electronic device may be a plurality of service nodes included in the distributed system, and specifically may be a target node selected by a load balancer from the plurality of service nodes. Here, each of the plurality of service nodes may be a server, a workbench, a large-scale computer, a conventional computer or any other similar hardware device, or may be a virtual node simulated inside a hardware device; and the plurality of service nodes may be simulated inside different hardware devices or inside a same hardware device.

At this point, the electronic device is configured to:
receive a current request sent by a load balancer;
generate a high load identifier of the target node when determining that processing the current request causes the target node to be in a high load state; and
send the high load identifier of the target node to the load balancer; where the load balancer is used to store the high load identifier of the target node.

It should be noted that the schematic diagram of the scenario shown in FIG. 4 is only illustrative and not restrictive in the embodiment of the present disclosure, those skilled in the art can make various obvious changes and/or replacements based on the example of FIG. 4, and the obtained technical solutions still belong to the disclosure scope of the embodiments of the present disclosure.

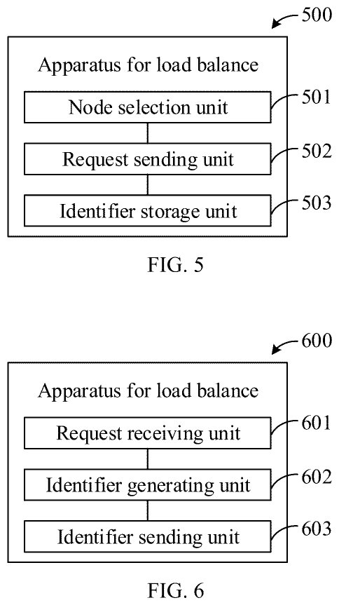

In order to better implement the first kind of method for load balance described above, an embodiment of the present disclosure further provides an apparatus for load balance, which may be applied to a load balancer included in the distributed system. Here, the load balancer may be a server, a workbench, a large-scale computer, a conventional computer or any other similar hardware device, or may be a virtual balancer simulated inside a hardware device. Moreover, it should be noted that the distributed system further includes a plurality of service nodes (i.e., candidate service nodes) connected to the load balancer in the embodiment of the present disclosure. Here, each of the plurality of service nodes may be a server, a workbench, a large-scale computer, a conventional computer or any other similar hardware device, or may be a virtual node simulated inside a hardware device; and the plurality of service nodes may be simulated inside different hardware devices or inside a same hardware device. Hereinafter, an apparatus for load balance 500 according to an embodiment of the present disclosure will be described in combination with the schematic structural block diagram shown in FIG. 5.

The apparatus for load balance 500 includes:
a node selection unit 501 configured to select a target node from a plurality of service nodes;
a request sending unit 502 configured to send a current request to the target node when determining that no high load identifier of the target node is stored in a load balancer; where the target node is used to generate and send a high load identifier of the target node to the load balancer when determining that processing the current request causes the target node to be in a high load state; and
an identifier storage unit 503 configured to store the high load identifier of the target node.

In some optional implementations, the node selection unit 501 is configured to:
obtain an overall load state of the plurality of service nodes;
select a first target strategy from a plurality of candidate strategies based on the overall load state of the plurality of service nodes; and
select the target node from the plurality of service nodes according to the first target strategy.

In some optional implementations, the node selection unit 501 is configured to:
determine a first selection strategy among the plurality of candidate strategies as the first target strategy when determining based on the overall load state of the plurality of service nodes that a high load proportion of the plurality of service nodes satisfies a preset medium/low proportion requirement; where the first selection strategy is used to indicate to select the target node from the plurality of service nodes by using a polling method or a hashing method; or
determine a second selection strategy among the plurality of candidate strategies as the first target strategy when determining based on the overall load state of the plurality of service nodes that the high load proportion of the plurality of service nodes satisfies a preset high proportion requirement; where the second selection strategy is used to indicate to select a service node with a lowest load from the plurality of service nodes as the target node.

In some optional implementations, the apparatus for load balance 500 further includes an identifier cleaning unit configured to:
obtain a duration threshold;
obtain a storage duration of the high load identifier of the target node in the load balancer; and
clear the high load identifier of the target node stored in the load balancer when determining that the storage duration is greater than or equal to the duration threshold.

In some optional implementations, the identifier cleaning unit is configured to:
obtain the duration threshold based on a first basic duration when the high load identifier of the target node is a first high load identifier; where the first high load identifier is used to indicate that processing the current request causes the target node to be in a nearly full load state under the high load state; or
obtain the duration threshold based on a second basic duration when the high load identifier of the target node is a second high load identifier; where the second high load identifier is used to indicate that processing the current request causes the target node to be in a full load state under the high load state; and the second basic duration is greater than the first basic duration.

In some optional implementations, the identifier cleaning unit is configured to:
obtain a state transition duration of the target node as a first incremental duration; where the state transition duration is used to indicate a length of time required for the target node to transition from the high load state to a medium/low load state; or
obtain a first incremental duration based on a current flow index of a distributed system; where the first incremental duration is positively correlated with the current flow index;
obtain the duration threshold based on the first basic duration and the first incremental duration.

In some optional implementations, the identifier cleaning unit is configured to:
obtain a state transition duration of the target node as a second incremental duration; where the state transition duration is used to indicate a length of time required for the target node to transition from the high load state to a medium/low load state; or
obtain a second incremental duration based on a current flow index of a distributed system; where the second incremental duration is positively correlated with the current flow index; and
obtain the duration threshold based on the second basic duration and the second incremental duration.

In the embodiment of the present disclosure, the specific functions and examples of the units in the apparatus for load balance 500 can refer to the relevant description of the corresponding steps in the above-mentioned embodiments of the method for load balance, and will not be repeated here.

In order to better implement the second method for load balance described above, an embodiment of the present disclosure further provides an apparatus for load balance, which may be applied to a plurality of service nodes included in the distributed system, and specifically, may be a target node selected by a load balancer from the plurality of service nodes. Here, each of the plurality of service nodes may be a server, a workbench, a large-scale computer, a conventional computer or any other similar hardware device, or may be a virtual node simulated inside a hardware device; and the plurality of service nodes may be simulated inside different hardware devices or inside a same hardware device. Hereinafter, an apparatus for load balance 600 according to an embodiment of the present disclosure will be described in combination with the schematic structural block diagram shown in FIG. 6.

The apparatus for load balance 600 includes:
a request receiving unit 601 configured to receive a current request sent by a load balancer;
an identifier generating unit 602 configured to generate a high load identifier of the target node when determining that processing the current request causes the target node to be in a high load state; and
an identifier sending unit 603 configured to send the high load identifier of the target node to the load balancer; where the load balancer is used to store the high load identifier of the target node.

In some optional implementations, the identifier generation unit 602 is configured to:
generate a first high load identifier of the target node when determining that processing the current request causes the target node to be in a nearly full load state under the high load state; or
generate a second high load identifier of the target node when determining that processing the current request causes the target node to be in a full load state under the high load state.

In the embodiment of the present disclosure, the specific functions and examples of the units in the apparatus for load balance 600 can refer to the relevant description of the corresponding steps in the above-mentioned embodiments of the method for load balance, and will not be repeated here.

In the technical solution of the present disclosure, the acquisition, storage and application of the user's personal information involved are in compliance with relevant laws and regulations, and do not violate public order and good customs.

According to the embodiments of the present disclosure, the present disclosure further provides an electronic device, a readable storage medium and a computer program product.

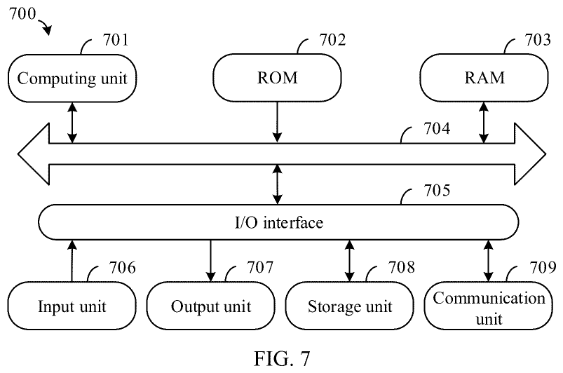

FIG. 7 shows a schematic structural block diagram of an exemplary electronic device 700 that may be used to implement the embodiments of the present disclosure. The electronic device is intended to represent various forms of digital computers, such as a vehicle-mounted computing device, a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar hardware devices. The components shown herein, their connections and relationships, and their functions are merely examples, and are not intended to limit the implementation of the present disclosure described and/or required herein.

As shown in FIG. 7, the electronic device 700 includes a computing unit 701 that may perform various appropriate actions and processes according to a computer program stored in a Read-Only Memory (ROM) 702 or a computer program loaded from a storage unit 708 into a Random Access Memory (RAM) 703. Various programs and data required for the operations of the electronic device 700 may also be stored in the RAM 703. The computing unit 701, the ROM 702 and the RAM 703 are connected to each other through a bus 704. The Input/Output (I/O) interface 705 is also connected to the bus 704.

A plurality of components in the electronic device 700 are connected to the I/O interface 705, and include: an input unit 706 such as a keyboard, a mouse, or the like; an output unit 707 such as various types of renderers, speakers, or the like; a storage unit 708 such as a magnetic disk, an optical disk, or the like; and a communication unit 709 such as a network card, a modem, a wireless communication transceiver, or the like. The communication unit 709 allows the electronic device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a CPU, a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 701 performs various methods and processing described above, such as the method for load balance. For example, in some implementations, the method for load balance may be implemented as a computer software program tangibly contained in a computer-readable medium, such as the storage unit 708. In some implementations, a part or all of the computer program may be loaded and/or installed on the device 700 via the ROM 702 and/or the communication unit 709. When the computer program is loaded into the RAM 703 and executed by the computing unit 701, one or more steps of the method for load balance described above may be performed. Alternatively, in other implementations, the computing unit 701 may be configured to perform the method for load balance by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, an RAM, an ROM, an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a rendering device (e.g., a Cathode Ray Tube (CRT) renderer or a Liquid Crystal Display (LCD)) for rendering information to the user; and a keyboard and a pointing device (e.g., a mouse or a trackball) through which the user may provide input to the computer. Other types of devices are also used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

An embodiment of the present disclosure further provides a non-transitory computer-readable storage medium storing a computer instruction thereon, and the computer instruction is used to cause a computer to execute the method for load balance described above.

An embodiment of the present disclosure further provides a computer program product including a computer program, and the computer program implements the method for load balance, when executed by a processor.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein. Moreover, the relational terms such as “first”, “second”, “third”, etc. in this disclosure are only used to distinguish one entity or operation from another entity or operation, and do not necessarily require or imply any such actual relationship or sequence between these entities or operations. Furthermore, “a plurality of” in the present disclosure can be understood as at least two.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

1. A method for load balance, comprising:
selecting a target node from a plurality of service nodes;
sending a current request to the target node after determining that no high load identifier of the target node is stored in a load balancer; wherein the target node is used to generate and send a high load identifier of the target node to the load balancer after determining that processing the current request causes the target node to be in a high load state; and
storing the high load identifier of the target node.

2. The method of claim 1, wherein the selecting a target node from a plurality of service nodes, comprises:
obtaining an overall load state of the plurality of service nodes;
selecting a first target strategy from a plurality of candidate strategies based on the overall load state of the plurality of service nodes; and
selecting the target node from the plurality of service nodes according to the first target strategy.

3. The method of claim 2, wherein the selecting a first target strategy from a plurality of candidate strategies based on the overall load state of the plurality of service nodes, comprises:
determining a first selection strategy among the plurality of candidate strategies as the first target strategy after determining based on the overall load state of the plurality of service nodes that a high load proportion of the plurality of service nodes satisfies a preset medium/low proportion requirement; wherein the first selection strategy is used to indicate to select the target node from the plurality of service nodes by using a polling method or a hashing method; or
determining a second selection strategy among the plurality of candidate strategies as the first target strategy after determining based on the overall load state of the plurality of service nodes that the high load proportion of the plurality of service nodes satisfies a preset high proportion requirement; wherein the second selection strategy is used to indicate to select a service node with a lowest load from the plurality of service nodes as the target node.

4. The method of claim 1, further comprising:
obtaining a duration threshold;
obtaining a storage duration of the high load identifier of the target node in the load balancer; and
clearing the high load identifier of the target node stored in the load balancer after determining that the storage duration is greater than or equal to the duration threshold.

5. The method of claim 4, wherein the obtaining a duration threshold, comprises:
obtaining the duration threshold based on a first basic duration in a case of the high load identifier of the target node is a first high load identifier; wherein the first high load identifier is used to indicate that processing the current request causes the target node to be in a nearly full load state under the high load state; or
obtaining the duration threshold based on a second basic duration in a case of the high load identifier of the target node is a second high load identifier; wherein the second high load identifier is used to indicate that processing the current request causes the target node to be in a full load state under the high load state; and the second basic duration is greater than the first basic duration.

6. The method of claim 5, wherein the obtaining the duration threshold based on a first basic duration, comprises:
obtaining a state transition duration of the target node as a first incremental duration; wherein the state transition duration is used to indicate a length of time required for the target node to transition from the high load state to a medium/low load state; or
obtaining a first incremental duration based on a current flow index of a distributed system; wherein the first incremental duration is positively correlated with the current flow index; and
obtaining the duration threshold based on the first basic duration and the first incremental duration.

7. The method of claim 5, wherein the obtaining the duration threshold based on a second basic duration, comprises:
obtaining a state transition duration of the target node as a second incremental duration; wherein the state transition duration is used to indicate a length of time required for the target node to transition from the high load state to a medium/low load state; or
obtaining a second incremental duration based on a current flow index of a distributed system; wherein the second incremental duration is positively correlated with the current flow index; and
obtaining the duration threshold based on the second basic duration and the second incremental duration.

8. A method for load balance, comprising:
receiving a current request sent by a load balancer;
generating a high load identifier of a target node after determining that processing the current request causes the target node to be in a high load state; and
sending the high load identifier of the target node to the load balancer; wherein the load balancer is used to store the high load identifier of the target node.

9. The method of claim 8, wherein the generating a high load identifier of the target node after determining that processing the current request causes the target node to be in a high load state, comprises:
generating a first high load identifier of the target node after determining that processing the current request causes the target node to be in a nearly full load state under the high load state; or
generating a second high load identifier of the target node after determining that processing the current request causes the target node to be in a full load state under the high load state.

10. (canceled)

11. (canceled)

12. An electronic device, comprising:
at least one processor;
a memory connected in communication with the at least one processor;
wherein the memory stores an instruction executable by the at least one processor, and the instruction, when executed by the at least one processor, enables the at least one processor to execute;
selecting a target node from a plurality of service nodes;
sending a current request to the target node after determining that no high load identifier of the target node is stored in a load balancer; wherein the target node is used to generate and send a high load identifier of the target node to the load balancer after determining that processing the current request causes the target node to be in a high load state; and
storing the high load identifier of the target node.

13. A non-transitory computer-readable storage medium storing a computer instruction thereon, wherein the computer instruction is used to cause a computer to execute the method of claim 1.

14. (canceled)

15. The electronic device of claim 12, wherein the instruction, when executed by the at least one processor, enables the at least one processor to execute the selecting of the target node from the plurality of service nodes, by:
obtaining an overall load state of the plurality of service nodes;
selecting a first target strategy from a plurality of candidate strategies based on the overall load state of the plurality of service nodes; and
selecting the target node from the plurality of service nodes according to the first target strategy.

16. The electronic device of claim 15, wherein the instruction, when executed by the at least one processor, enables the at least one processor to execute the selecting of the first target strategy from the plurality of candidate strategies, by:
determining a first selection strategy among the plurality of candidate strategies as the first target strategy after determining based on the overall load state of the plurality of service nodes that a high load proportion of the plurality of service nodes satisfies a preset medium/low proportion requirement; wherein the first selection strategy is used to indicate to select the target node from the plurality of service nodes by using a polling method or a hashing method; or
determining a second selection strategy among the plurality of candidate strategies as the first target strategy after determining based on the overall load state of the plurality of service nodes that the high load proportion of the plurality of service nodes satisfies a preset high proportion requirement; wherein the second selection strategy is used to indicate to select a service node with a lowest load from the plurality of service nodes as the target node.

17. The electronic device of claim 12, wherein the instruction, when executed by the at least one processor, enables the at least one processor to further execute:
obtaining a duration threshold;
obtaining a storage duration of the high load identifier of the target node in the load balancer; and
clearing the high load identifier of the target node stored in the load balancer after determining that the storage duration is greater than or equal to the duration threshold.

18. The electronic device of claim 17, wherein the instruction, when executed by the at least one processor, enables the at least one processor to execute the obtaining of the duration threshold, by:
obtaining the duration threshold based on a first basic duration in a case of the high load identifier of the target node is a first high load identifier; wherein the first high load identifier is used to indicate that processing the current request causes the target node to be in a nearly full load state under the high load state; or
obtaining the duration threshold based on a second basic duration in a case of the high load identifier of the target node is a second high load identifier; wherein the second high load identifier is used to indicate that processing the current request causes the target node to be in a full load state under the high load state; and the second basic duration is greater than the first basic duration.

19. The electronic device of claim 18, wherein the instruction, when executed by the at least one processor, enables the at least one processor to execute the obtaining of the duration threshold, by:
obtaining a state transition duration of the target node as a first incremental duration; wherein the state transition duration is used to indicate a length of time required for the target node to transition from the high load state to a medium/low load state; or
obtaining a first incremental duration based on a current flow index of a distributed system; wherein the first incremental duration is positively correlated with the current flow index; and
obtaining the duration threshold based on the first basic duration and the first incremental duration.

20. The electronic device of claim 18, wherein the instruction, when executed by the at least one processor, enables the at least one processor to execute the obtaining of the duration threshold, by:
obtaining a state transition duration of the target node as a second incremental duration; wherein the state transition duration is used to indicate a length of time required for the target node to transition from the high load state to a medium/low load state; or
obtaining a second incremental duration based on a current flow index of a distributed system; wherein the second incremental duration is positively correlated with the current flow index; and
obtaining the duration threshold based on the second basic duration and the second incremental duration.

21. An electronic device, comprising:
at least one processor;
a memory connected in communication with the at least one processor;
wherein the memory stores an instruction executable by the at least one processor, and the instruction, when executed by the at least one processor, enables the at least one processor to execute the method of claim 8.

22. A non-transitory computer-readable storage medium storing a computer instruction thereon, wherein the computer instruction is used to cause a computer to execute the method of claim 8.
